(19) United States
(12) Patent Application Publication
(10) Pub. No.: US 2010/0127445 A1
(43) Pub. Date: May 27, 2010

(54) CONDOM HOLDER PROVIDED WITH MEANS FOR RELEASING THE CONDOM FROM THE HOLDER, AND A METHOD OF PUTTING THE CONDOM ON

(76) Inventor: Alexander Leonidovich Felitsyn, Saint Petersburg (RU)

Correspondence Address: Maria Nilova;PATENTICA LLC, Sadovaya Street, 51, Office 303, Saint Petersburg, 190068, omitted

(21) Appl. No.: 12/594,942

(22) PCT Filed: Apr. 30, 2008
(86) PCT No.: PCT/RU08/00290

§ 371 Date: Oct. 7, 2009

(30) Foreign Application Priority Data
May 2, 2007 (RU) 2007117861

(51) Int. Cl. B25B 3/00

(52) U.S. Cl. 269/2

(57) ABSTRACT

A condom holder is suggested along with a method of putting on the condom with said holder.

The suggested condom holder comprises a means of releasing the condom from the holder at least partially defining a space in which the flatly arranged condom can be placed, and fasteners, each of which includes a hook and is adapted for receiving the edge of the rolled condom therein, and the connection between said fasteners. The holder is formed in such manner that at least one fastener can be rotated, and the rotation ability of at least one said fastener is provided in a direction opposite to that in which the hook of said fastener is bent, and the holder includes a stopper preventing the rotation of said fastener in a direction in which the hook of said fastener is bent.

The method and the device of the invention allow the user to put on the condom and subsequently remove the holder in a quick and comfortable way, only slightly distracting the user from sexual intercourse.

### CROSS-REFERENCE TO RELATED APPLICATIONS

This application claims the benefits from International Application PCT/RU2008/000290 filed on Apr. 30, 2008 and priority application RU 2007117861 filed on May 2, 2007. The contents of these applications are hereby incorporated by reference and in their entirety.

### FIELD OF THE INVENTION

The present invention relates to barrier contraceptives, in particular to a condom holder.

### BACKGROUND ART

A condom is a skin made of natural latex or another material, covering the penis entirely or partially. Condoms are used to protect from sexually transmitted diseases and/or undesirable pregnancy. A traditional condom is shown in FIG. 1. A condom can also be a so-called micro-condom covering only the balanus.

To make it compact and easy to use, a condom is usually rolled into ring. Actually, it can also be rolled in an opposite direction to that traditionally used for rolling a condom. A condom can also be bellowed or otherwise folded. When stored, a condom is usually sealingly packed into a skin generally formed as a package of an elastic sheet material which is usually strong enough to provide tightness and protect the condom during storage and transportation. A package is usually provided with means facilitating its unpacking, e.g. a notch or reduced-strength area at its side, or a sealed ribbon with one its end extending outside the package. When unpacked, a condom is applied to erected penis and then rolled down to the penis root.

It can be unnecessary to unroll down a micro-condom because it covers only the balanus. Therefore, a micro-condom only requires a minimal degree of unrolling, if any.

The main disadvantage of traditional condoms is that it takes a long time and much effort to unpack and put on a condom. As a result, the user's attention is distracted away from sexual intercourse.

It is also necessary to use both hands to put the condom on. However, typically, the user has only one free hand, and uses the other one to support himself or has it under woman's head (see FIG. 2). The movements of this hand are therefore restricted. Generally, this position is uncomfortable, and the user can release his second hand only for a short time. Therefore, for unpacking and putting on the condom, the user can only use one hand freely, occasionally using the second hand.

When putting on a condom, every moment spent can be critical for the user. Requirements for swift, convenient and easy handling of condom package are much higher than those for any other packed product used in private life. Besides, it is known that some people do not use condoms even when necessary, and the main reason for this is that they have to spend a long time and much effort to put a condom on, resulting in distraction of their minds from the sexual intercourse. The object is to simplify and reduce the number of steps required to unpack and put on a condom. If this problem is solved,

a) the overall condom usage will increase; whereas

b) the number of people who either do not use condoms at all, or use them rarely while having risky sexual intercourses, will decrease.

This could help to solve the spreading HIV problem as well as decrease the uncontrolled birth rate growth (especially in overpopulated developing countries).

Devices known as condom holders hold a condom, in most cases hold the edge of a rolled condom, and therefore allow the user grasp a condom holder and put the condom on by applying the condom on top of and down the penis. In this process, the condom is unrolled along the penis shaft (where a pre-rolled condom is used).

A condom holder can be a hollow ring with a groove extending along its circumference and defining a recess for receiving a condom. The shape and location of the groove can vary (e.g., see U.S. Pat. No. 4,738,357, Martin et al, 1988).

When the inner diameter of the holder is greater than or equal to the inner diameter of the condom ring, the recess can open to the outside. In this case, forces arise directed to the center of the condom ring, which do not let this ring pop out of the groove.

This kind of holder is disclosed in the following patents: JP6154260 (Toshihiro, 1994), JP7308336, Tadashi, 1995), U.S. Pat. No. 5,579,784 (Harari, 1996), DE19641107 (Raabe, 1998), U.S. Pat. No. 5,437,286 (Stratton, 1995), FR2751869 (Loyer, 1998).

Also known are condom holders either embracing the whole condom ring (e.g. see U.S. Pat. No. 5,163,449, van der Valk 1992) or having one discontinuity, either C-shaped or U-shaped (e.g. see U.S. Pat. No. 4,875,491, Parrone, 1989).

Furthermore, holders can either hold the condom ring with spaced fasteners (e.g. see FR2727858, Vegega, 1996) or continuously along the whole circumference of the ring.

Other means of holding the edge of a rolled condom can be used, e.g. the condom ring can be held by a pair of rollers (e.g. see WO9801095, Liehs, 1999).

A condom holder WO2007/021184 (Tunovic Adnan et al, 2007), is known that consists of two parts, each of said parts comprises at least one fastener formed as a number of nooses grasping the condom ring on the outer side. Due to the fact that penis contacts the fasteners through the condom, there is much less discomfort for the user than in case when the holder's fasteners embrace the condom ring on the inner side, thus contacting the penis directly.

A holder is also known consisting of two parts which are to be held with both hands (see WO02/069861, Van Rensburg, 2002).

A holder that seems to be the closest to the one claimed herein is described in FR2727858 (Vegega, 1996). The holder is provided with fasteners, each fastener including a hook adapted for receiving the edge of the rolled condom therein, and a connection between said fasteners. The fasteners are mounted on the holder and adapted to rotate in the same direction in which the hooks are bent.

This design allows to put a condom on a penis of any diameter by changing the angle to which the fastener is rotated. However, when putting on the condom, the fasteners of the holder are in contact with penis, which may cause discomfort for the user.

Furthermore, there is a problem of releasing the holder from the condom. After the condom is put on, the diameter of the rolled condom ring is reduced (the condom is of standard length and is usually not fully unrolled), but the condom ring remains in the fasteners. In other words, the reduction of the condom ring diameter does not lead to the automatic release of the condom ring from the holder.

A modification of said holder is possible, in which the condom is retained in stretched shape, which allows to avoid the contact between the holder and the penis. In this embodiment, the condom ring is retained in the fasteners by elastic force created by the condom ring and oriented towards the center of the holder. After the condom is put on, said force is reduced but is still sufficient, and the condom ring rests against the fasteners. In order to release the condom from the holder, the user is required to hold the holder with one hand and the condom ring near the fastener in the other hand, and thus release the condom. In order to perform said procedure, it is necessary to use both hands; furthermore, the condom is slippery and lubricious. The necessity to use both hands to remove the holder from the condom ring nullifies the potential advantage of the holder that is put on using one hand. Thus, the significant effort of removing the holder from the condom distracts the user from sexual intercourse.

Furthermore, the condom can partially roll back up along the penis as a result of said procedure of removing the condom from the holder. Also, the user's digits can become greased with lubricant, which is uncomfortable for some users. The lubricant is removed from the condom, which may cause discomfort for the users.

In WO02069861 (Van Rensburg, 2002), a condom holder is described comprising fasteners formed as hooks and adapted to break into two halves. The user puts the condom on, while holding halves of the holder with both hands and displacing said holder towards the base of the penis. As it can be understood from the holder design, in order to separate the holder and the condom, the user rotates halves of the holder with respect to the penis in a direction opposite to that in which the hooks of said fasteners are bent. Said hooks are placed on each half in such way that the condom ring is released from the fasteners of the holder. Therefore, in order to put the condom on and to release it from the holder, the user is required to use both hands.

A method of putting on the condom that seems to be the closest to the one claimed herein is described in FR2727858 (Vegega, 1996). According to said method, a condom retained by a holder provided with fasteners, each of which includes a hook and is adapted for receiving the edge of rolled condom therein, is put on by holding the holder in one hand and displacing it towards the base of the penis. Afterwards, the user opens the holder by tearing it at a weakened area and removes said holder in transverse direction. As the condom is being put on, the rolled condom ring diameter is reducing, but the ring is not automatically released from the fasteners. Therefore, in order to release the condom ring from the fasteners, the user is required to use his second hand, which (as mentioned before) is uncomfortable and nullifies the potential advantage of said holder.

Notably, it is impossible or at least very difficult to release the condom from the holder provided with fasteners formed as hooks and the O-shaped or C-shaped connection (embracing the penis from different sides) by rotating the holder with respect to the penis, due to the fact that an attempt to release the fasteners on one side is hindered by the fasteners on the other side. Furthermore, the condom can become lapsided and even partially slide from the penis.

The purpose of this invention is to provide a condom holder provided with fasteners formed as hooks connected to each other thus forming a framework which can be held in one hand; said holder provides the procedures of putting on the condom and subsequent reliable, quick and convenient removal of the holder. It is preferrable that all actions performed while putting on the condom are performed using one hand, and it is possible to remove the holder in lateral direction after the condom is put on; therefore, the procedure of putting on the condom causes only minimal distraction of the user from sexual intercourse.

### BRIEF SUMMARY OF THE INVENTION

The problem is solved by providing a condom holder which comprises a means of releasing the condom from the holder at least partially defining a space in which the flatly arranged condom can be placed, at least one fastener with a hook adapted for receiving the edge of the rolled condom therein, and the connection between said fasteners. The holder is formed in such manner that at least one fastener can be rotated, and the rotation ability of at least one said fastener is provided in a direction opposite to that in which the hook of said fastener is bent.

Thus, only one hand is required to put on the condom and subsequently remove the holder using simple motion of the digits of said hand. Due to the fact that the fasteners are adapted to rotate, the quick and convenient removal of the holder is provided.

The holder can include a stopper preventing the rotation of said fastener in a direction in which the hook of said fastener is bent.

At least one fastener can be adapted to rotate with respect to the connection or along with the connection.

The stopper can prevent the rotation of the fasteners above the condom plane.

The rotation ability can be provided by a hinge joint.

The rotation ability can be provided by a elastic connector.

At least two fasteners can be adapted to rotate simultaneously.

The connection can include at least one arc-shaped band.

The holder can be provided with a handle placed on the outer side of said arc-shaped band.

The holder can be adapted to change the shape of said connection between a first configuration in which said space is reduced, and a second configuration in which said space is expanded.

Said connection can be elastic.

The holder can be provided with a holder locking device for locking the holder in second configuration.

The holder can be provided with an elastic member tending to return the holder into first configuration.

The holder can include at least three fasteners arranged in such manner that it is possible to draw a radial arc with angular value of at least 180° through said fasteners.

The fasteners can be noose-shaped and adapted to hold the edge of a rolled condom on the outer side of said condom.

The holder can include two fasteners adapted to rotate with respect to the connection simultaneously.

The fasteners can be adapted to hold the rolled condom ring on the inner side of said condom.

Furthermore, the problem is solved by providing a condom holder which comprises a means of releasing the condom from the holder at least partially defining a space in which the flatly arranged condom can be placed, at least one fastener with a hook adapted for receiving the edge of the rolled condom therein, and the connection between said fasteners. The holder is formed in such manner that at least one fastener can be rotated, and the holder is provided with at least one rotating means adapted to be affected by the digits of a hand and connected to at least one said fastener providing a rotation ability of said fastener in a direction opposite to that in which the hook of said fastener is bent.

At least one fastener can be adapted to rotate with respect to the connection or along with the connection.

The holder can include a stopper preventing the rotation of said fastener in a direction in which the hook of said fastener is bent.

The holder can include a stopper preventing the rotation of the fastener above the condom plane.

The rotation ability can be provided by a hinge joint or a elastic connector.

At least two fasteners can be adapted to rotate simultaneously.

The connection can include at least one arc-shaped band.

The holder can be provided with a handle placed on the outer side of said arc-shaped band.

The rotating means can include a lever.

The holder can be adapted to change the shape of said connection between a first configuration in which said space is reduced, and a second configuration in which said space is expanded.

The holder can be provided with a holder locking device for locking the holder in second configuration.

The holder can be provided with an elastic member tending to return the holder into the first configuration.

The holder can include at least three fasteners arranged in such manner that it is possible to draw a radial arc with angular value of at least 180° through said fasteners.

The holder can include a mobile connector connecting the fasteners, and means of dispacing the mobile connector in a direction perpendicular to the condom plane; the rotation ability of the fasteners is provided by said displacement of said connector.

The means of displacing the connector can include a lever, one end of which is attached to the mobile connector and the other end is adapted to be affected by the digits of a hand; the pivot of the lever is located on the connection between said fasteners.

The holder can include a locking means for locking the fasteners in home position connected to the means of displacing the the mobile connector.

Furthermore, the problem is solved by providing a condom holder which comprises a means of releasing the condom from the holder at least partially defining a space in which the flatly arranged condom can be placed, at least one fastener with a hook adapted for receiving the edge of the rolled condom therein, and the connection between said fasteners. The holder includes at least one condom edge pushing member provided with a means of affecting said pushing member by the user by contacting said pushing member and the edge of the condom and displacing said edge with respect to at least one hook.

The fasteners can be adapted to hold the rolled condom ring on the inner side of said condom.

The fasteners can be noose-shaped.

The fasteners can be adapted to hold the rolled condom ring on the outer side of said condom.

The pushing member can include a ribbon.

The ribbon can be attached to the hook.

The ribbon can be placed on the inner side of the hook.

The ribbon can embrace the hook and its other end can be attached to the connection.

The pushing member can include a semi-ring placed on the inner side of the hook.

The holder can include at least one more pushing member, and a means of simultaneously affecting said pushing members.

The holder can include a guideway, and the pushing member can include a plate with U-shaped profile adapted to displace along said guideway.

Furthermore, the problem is solved by providing a method of putting on the flatly arranged condom held by a holder provided with at least three fasteners arranged in such manner that it is possible to draw a radial arc with angular value of at least 180° through said fasteners, each of which includes a hook and is adapted for receiving the edge of the rolled condom therein, the holder is also provided with a connection between said fasteners and at least one fastener is adapted to rotate in a direction opposite to that in which the hook of said fastener is bent and subsequently detach from at least one said fastener; according to this method, the user puts on the condom by holding the holder in one hand and displacing it towards the base of the penis, while rotating at least one said fastener in a direction opposite to that in which the hook of said fastener is bent by affecting the rotating means connected to at least one said fastener with digits of the same hand.

Said action is performed with digits of the same hand holding the holder.

Said action is performed on the lever.

Said action is pressing.

The pressing is performed on the holder in condom plane on both sides.

Said action is performed on a button connected to the holder.

Said action can be pressing or displacing the button.

In some modifications, at least two fasteners adapted to rotate simultaneously are rotated; in other modifications, all fasteners adapted to rotate simultaneously are rotated.

Before the condom is put on, it is stretched by affecting the holder, and said connection between the fasteners is retained in a position, in which the condom is stretched by a retaining device connected to the holder.

The fixation of the holder is withdrawn before the fastener is pressed.

Said rotation of at least one fastener is performed by pressing said connection between fasteners to the penis.

The fixation of the holder is withdrawn by affecting the button connected to the holder. Said action can be pressing or displacing the button.

### BRIEF DESCRIPTION OF THE DRAWINGS

Below is a detailed description of the invention with references to the attached drawings, in which:

FIG. 1 is a perspective view of the traditional condom held in hand by the user;

FIG. 2 illustrates the situation preceding the process of putting on the condom;

FIG. 3 is a perspective view of the holder in its another embodiment;

FIG. 4 is a perspective view of the holder shown in FIG. 3, with a condom separated from a holder;

FIGS. 5-6 are schematical side views of a part of the holder shown in FIG. 3, illustrating the process of putting on a condom with the holder shown in FIG. 3;

FIGS. 7-9 are perspective views of the process of putting on the condom with the holder shown in FIG. 3;

FIG. 10 is a perspective view showing another embodiment of the holder;

FIG. 11-13 are schematical side views showing another embodiment of a part of the holder, illustrating the process of putting on a condom with said holder;

FIG. 14 is a perspective view showing another embodiment of the holder with a condom therein;

FIG. 15 is an exploded view of the parts of the holder shown in FIG. 14;

FIG. 16 is a perspective view of the process of putting on the condom with the holder shown in FIG. 14;

FIG. 17 is a perspective view showing another embodiment of the holder;

FIG. 18 is an exploded view of the parts of the holder shown in FIG. 17;

FIG. 19 is a perspective view showing another embodiment of the holder;

FIG. 20 is an exploded view of the parts of the holder shown in FIG. 19;

FIG. 21 is a schematical side view of the holder shown in FIG. 19;

FIG. 22 is an exploded view of the parts of the holder shown in FIG. 19;

FIGS. 23-25 are perspective views of the process of putting on the condom with the holder shown in FIG. 19;

FIG. 26 is a perspective view showing another embodiment of the holder;

FIG. 27 is a cutaway view of the holder shown in FIG. 26 with a condom therein;

FIG. 28 is a perspective view of the holder shown in FIG. 26 with a button removed;

FIG. 29 is a perspective view illustrating the process of rotating the fasteners in the holder shown in FIG. 26;

FIG. 30 is a schematical view of a section of the holder shown in FIG. 26;

FIG. 31 is a schematical view of a section of the holder shown in FIG. 29;

FIG. 32 is a perspective view showing another embodiment of the holder;

FIGS. 33-34 are perspective views of the process of putting on the condom with the holder shown in FIG. 32;

FIG. 35 is a perspective view showing another embodiment of the holder;

FIGS. 36-37 are schematical side views of a part of the holder shown in FIG. 35, illustrating the process of putting on a condom with the holder shown in FIG. 35;

FIGS. 38-39 are schematical views showing another embodiment of parts of the holder;

FIG. 40 is a perspective view showing another embodiment of the holder;

FIG. 41-42 are schematical side views of a part of the holder shown in FIG. 40, illustrating the process of putting on a condom with the holder shown in FIG. 40;

FIG. 43 is a perspective view showing another embodiment of the holder;

FIGS. 44-45 are schematical side views of a part of the holder shown in FIG. 43, illustrating the process of putting on a condom with the holder shown in FIG. 43;

FIG. 46 is a perspective view showing another embodiment of the fasteners used in a holder;

FIGS. 47-48 are schematical side views of a part of the fasteners shown in FIG. 46, illustrating the process of putting on a condom with the holder provided with fasteners shown in FIG. 46;

FIG. 49 is a perspective view showing another embodiment of the fastener used in a holder;

FIG. 50 is a perspective view showing another embodiment of the fasteners used in a holder;

FIGS. 51-52 are schematical side views of a part of the fasteners shown in FIG. 50, illustrating the process of putting on a condom with the holder provided with fasteners shown in FIG. 50;

FIG. 53 is a perspective view showing another embodiment of the holder with a condom therein;

FIG. 54 is a perspective view of the holder shown in FIG. 44, after the condom is removed;

FIGS. 55-56 are schematical side views of a part of the holder shown in FIG. 53, illustrating the process of putting on a condom with the holder shown in FIG. 53;

FIG. 57 is a perspective view showing another embodiment of the holder;

FIG. 58 is an exploded view of the parts of the holder shown in FIG. 57;

FIG. 59 is a perspective view of the holder shown in FIG. 57, with a condom therein;

FIG. 60 is a perspective view of the arrangement after a condom is separated from the holder shown in FIG. 57;

FIGS. 61-62 are schematical side views of a part of the holder shown in FIG. 57, illustrating the process of putting on a condom with the holder shown in FIG. 57;

FIG. 63 is a perspective view showing another embodiment of the holder;

FIG. 64 is an exploded view of the parts of the holder shown in FIG. 63;

FIG. 65 is a perspective view of the holder shown in FIG. 63, with a condom therein;

FIG. 66 is a perspective view of the arrangement after a condom is separated from the holder shown in FIG. 63;

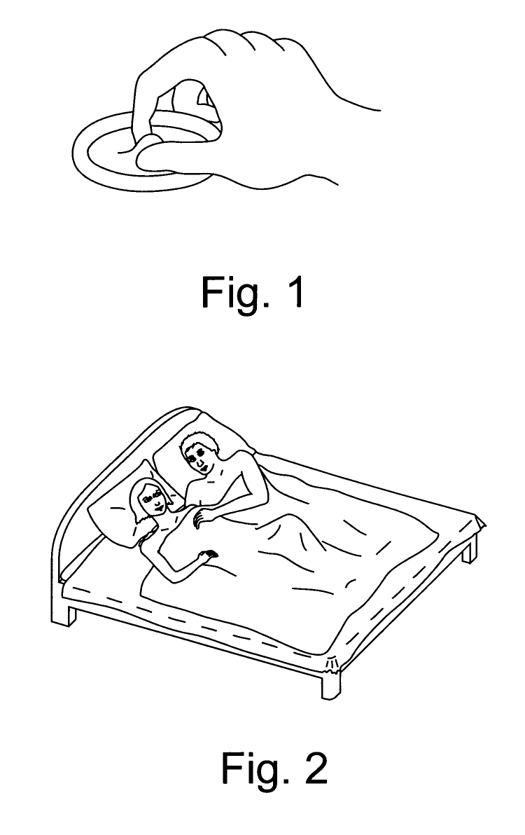

### DETAILED DESCRIPTION OF THE INVENTION

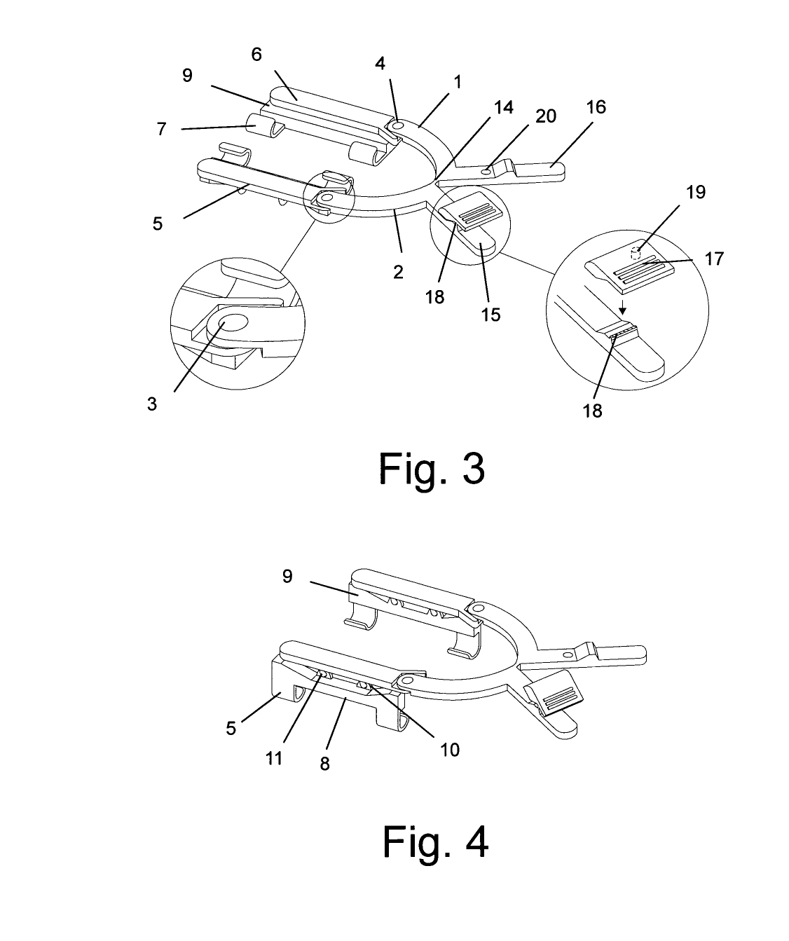

In FIGS. 3-9, one embodiment of the invention is represented. In this embodiment, a holder 1 includes a nonelastic arc-shaped band 2 with two nonelastic bands 5 and 6 attached to said band with hinges 3 and 4 (FIG. 3). Fasteners 7 are formed as hooks and connected pairwise with planks 8 and 9 (FIG. 4), each of said planks includes ears 10 (FIGS. 4, 6) attached to the bands 5 and 6 with nooses 11 (FIGS. 4, 6). Such connection of planks 8 and 9 to the bands 5 and 6 provides the rotation of planks 8 and 9 and, consequently, of fasteners 7 in a direction opposite to that in which the hooks of the fasteners are bent.

Edge 12 of a condom 13 is rolled into a ring and placed in the hooks, except for the end of condom, which covers the area formed by the band 2. The plane passing through the equator of the condom rolled into a ring, is herein referred to as the condom plane.

The shape of the hooks is selected to allow the edge 12 of the rolled condom 13 to be firmly retained in the hooks when putting on the condom (FIG. 7). The fasteners are preferrably from 5 mm to 1 cm wide in the circular direction. However, it is possible to use wider fasteners, about 25 mm. Furthermore, a modification is possible where the holder includes only one fastener formed as a hook, and the other fasteners are formed in another way, e.g. as ribbons rolled into the condom.

The arc-shaped band 2 includes an elastic connector 14 with handles 15 and 16 formed on both sides of said band. Handles 15 and 16 and the arc-shaped band 2 form a leverage with a rotation axis placed on the connector 14.

The holder is provided with a locking device 17 (FIG. 3), placed on the handle 16 and locking handles 15 and 16 with respect to each other, as shown in FIG. 7. As shown in FIG. 3, the retaining device is a plate attached to the handle 15 by a hinge joint with an elastic connector 18; said plate includes a lug 19; an opening 20 is placed on the handle 16 and is used to fix the lug 19.

Prior to putting on the condom as shown in FIGS. 7-9, handles 15 and 16 are brought together and fixed by the locking device 17. The area defined by the holder is therefore expanded, and the condom is stretched as shown in FIG. 7.

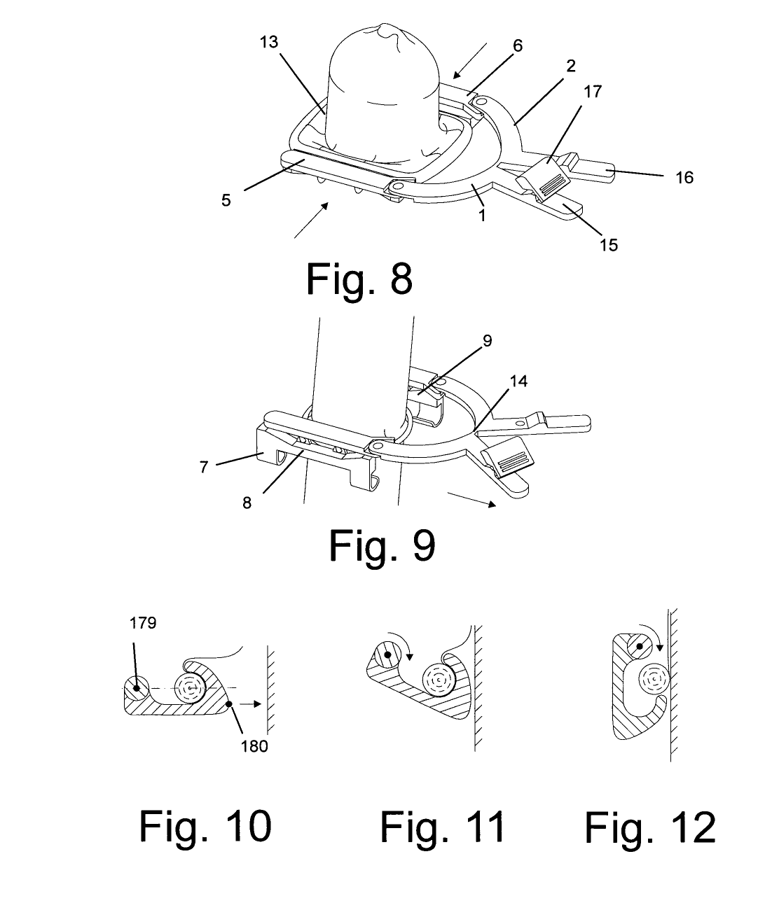

When putting the condom on, the holder 1 is displaced towards the base of the penis, holding said holder with digits of a hand by the handles 15 and 16. Then the fixation of the handles is withdrawn and the bands 5 and 6 are displaced towards each other due to elastic forces forming in the edge 12 of the condom 13; the fasteners 7 rest upon the penis. However, the force with which the fasteners rest upon the penis is insufficient for the fasteners to start rotating in a direction opposite to that in which the hooks of the fasteners are bent. In order to rotate the fasteners, the user can press the bands 5 and 6 with digits of his hand (in FIG. 8, the pressing direction is shown with arrows). The fasteners 7 are rotated in the direction opposite to that in which the hooks of the fasteners are bent. When the fasteners are rotated about a certain angle, the edge 12 of the condom 13 can leave the hooks of the fasteners without hindrance. After the edge 12 of the condom 13 is released, the holder is removed in transverse direction (FIG. 9).

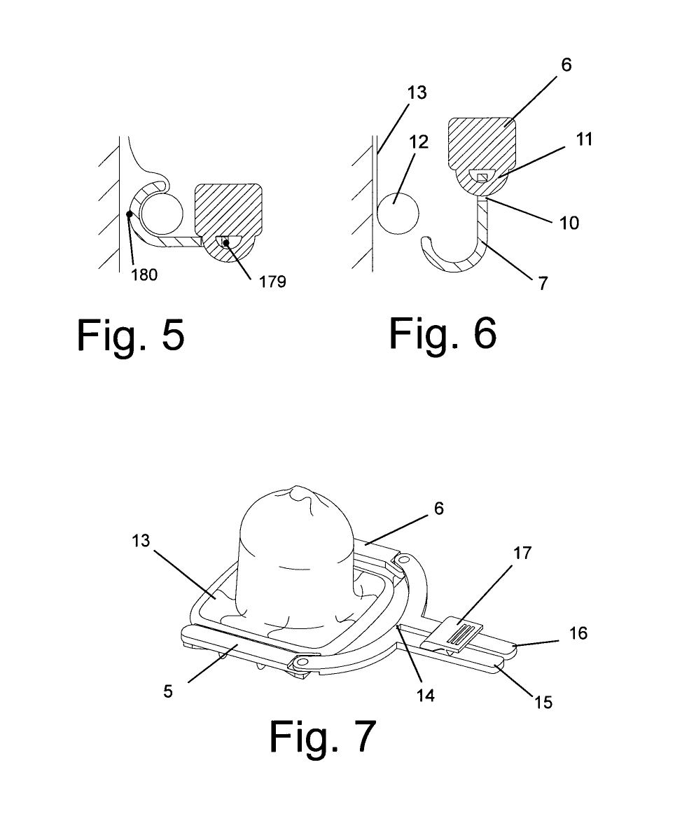

As shown in FIG. 5, an axis 179 of the rotation of fasteners 7 resting upon the penis is located lower than the point of contact 180 between said fasteners and the penis. In said relative position of the axis 179 and the point 180, it is necessary to restrict the rotation of fasteners in opposite direction in order to provide secure rotation of the fasteners in a direction opposite to that in which the hooks of the fasteners are bent. In another embodiment of the hooks shown in FIG. 10-12, an axis 179 of the rotation of fasteners resting upon the penis is located higher than the point of contact 180 between said fasteners and the penis, which allows to rotate the fasteners in a required direction.

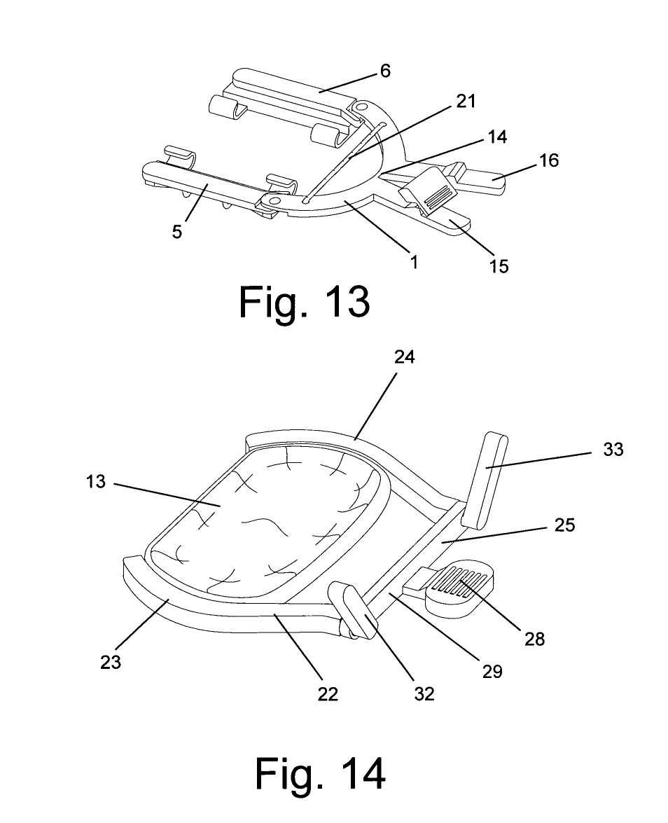

The holder design can be such that the user is not required to additionally press the bands 5 and 6 after the locking device is removed and the fasteners move closer to the penis. In the embodiment represented in FIG. 13, the connector 14 is elastic, and the holder 1 is provided with an elastic ribbon 21 which is stretched prior to removal of the locking device. After the fixation is removed, elastic forces forming in the ribbon 21 tend to displace bands 5 and 6 towards each other. As a result of said displacement, the fasteners rest upon the penis with force, and are subsequently rotated.

In this embodiment, in order to release the condom from the holder, the user is required to perform only one action; the user must remove the locking device from the holder (e.g. by pressing or sliding a button), thus the distraction of the user from sexual intercourse is minimal.

Said additional pressing of bands 5 and 6 can be provided in a different way. E.g., the connector 14 can be elastic, and the area defined by the holder can be somewhat smaller than the mean diameter of the penis after the fixation is removed. When the holder is retained in a state when the area defined by said holder is expanded, the connector is strained. After the locking is removed, elastic forces forming in the connector 14 tend to move the holder into a state when the area defined by said holder is reduced, and bands 5 and 6 rest upon the penis.

It is clear that the locking device can be formed in some other way. E.g. the locking device can be a shifting button, or a ring put on the handles 15 and 16 fastening said handles with respect to each other (not shown in figures).

Furthermore, in order to release the condom from the holder, it is possible not to rest all fasteners at once upon the penis, but only some of the fasteners, or to rest said fasteners upon the penis alternately.

A modification is possible where e.g. one fastener rests upon the penis. It is sufficient to release the condom from the other fasteners at some rotation angle of the holder in a direction opposite to that in which the hooks are bent.

The band 2 connecting the fasteners can be ring-shaped (C-shaped) or shaped differently. It is significant that the band 2 is a connection between the fasteners, interconnecting said fasteners and allowing to displace them simultaneously holding the band 2 in one hand.

The holder can also be provided with a holder unfolding device (not shown in figures). Said device can be e.g. a spring connected to the band 2. When the condom is stored, the holder is folded and the spring is strained by some retaining device, e.g. the package said spring rests upon. Said device allows keeping the condom in the holder in unstretched state. When unpacking the condom, the retaining device is removed, the spring of the holder is released and stretches the condom. Other designs of the unfolding device are possible.

Means of rotating the fasteners in a direction opposite to that in which the hooks of the fasteners are bent can be provided in different ways. E.g., the rotation of the fasteners can be provided by an elastic member (spring) connected to the fasteners or to the connection between said fasteners (not shown in figures). When the holder is stored, the elastic member is strained or it is strained during the unpacking process. Removal of the fixation provides elastic forces that rotate the fasteners, or rotate the fasteners with the connection.

An embodiment of holder design is possible where methods of releasing the condom from the fasteners are combined, particularly the method described with reference to FIGS. 3-9, in which the fasteners are rotated during the interaction with the penis, and a method where the fasteners are rotated by rotating means, e.g. levers. Combined use of said methods allows to alleviate the rotation of the fasteners and also reduce the impact on the penis. In other words, the fact that the fasteners rest upon the penis alleviates the rotation of the fasteners by rotating means.

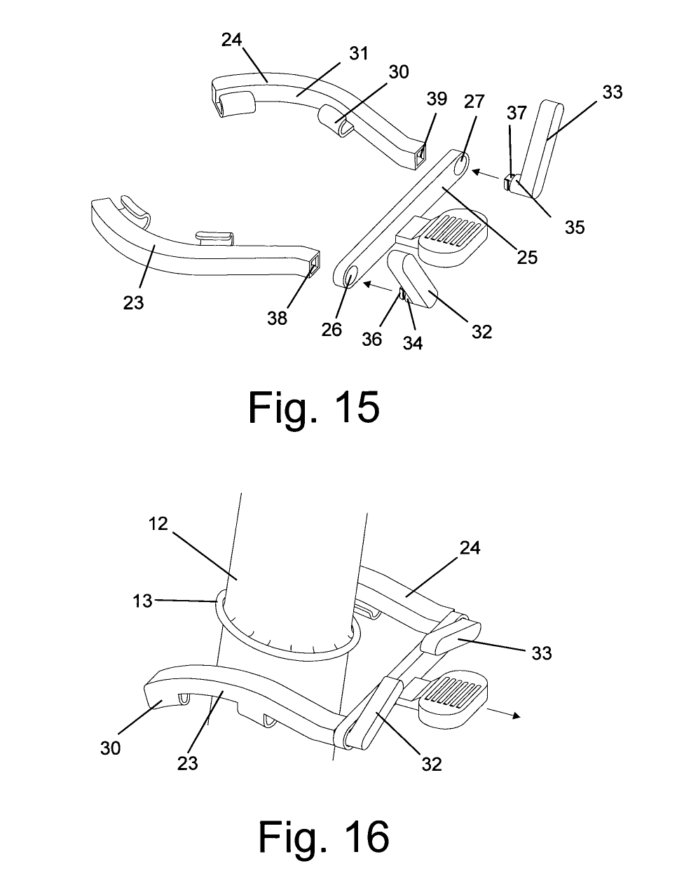

The rotation of the fasteners is possible not only around the part of the holder connecting said fasteners (e.g. the band 2), but also together with said part. It is possible as in the holder providing the rotation of the fasteners by resting said fasteners upon the penis, as in modification where the fasteners are rotated by rotating means. E.g., in the embodiment represented in FIGS. 14-16, a holder 22 includes two bands 23 and 24 connected with a connector 25 which includes openings 26 and 27 on two opposite ends thereof (FIG. 15). The holder 22 is provided with a handle 28 placed on the outer side 29 of the connector 25; said handle is used for holding the holder when putting the condom on.

As shown in FIG. 15, the holder 22 is also provided with fasteners 30 placed on the inner side 31 of the holder 22 and rigidly connected to said holder.

Bands 23 and 24 are connected to handles 32 and 33 allowing to rotate bands 23 and 24 with respect to the connector 25. Handles 32 and 33 are provided with axes 34, 35 on one end; said axes are transverse with respect to the handle and are adapted to rotate in the openings 26, 27 respectively. The diameter of axes 34, 35 matches the diameter of openings 26 and 27. A locking member 36 and 37 of square section is placed on the end of each axis, and each band 23, 24 is provided with a slot 38, 39 of square section on each end; said slot is used to place the locking member 36, 37 therein.

The process of putting on the condom is shown in FIG. 16. When putting the condom 13 on, the user holds the holder 22 with digits of a hand by a handle 28 and displaces said holder 22 towards the base of the penis. Then the user affects the handles 32 and 33, rotating said handles towards each other. Bands 23, 24 and, subsequently, fasteners 30 are therefore rotated. When the fasteners are rotated about a certain angle, the edge 12 of the condom 13 can leave the hooks of the fasteners without hindrance. After the edge 12 of the condom 13 is released, the holder is removed in transverse direction, as shown in FIG. 16.

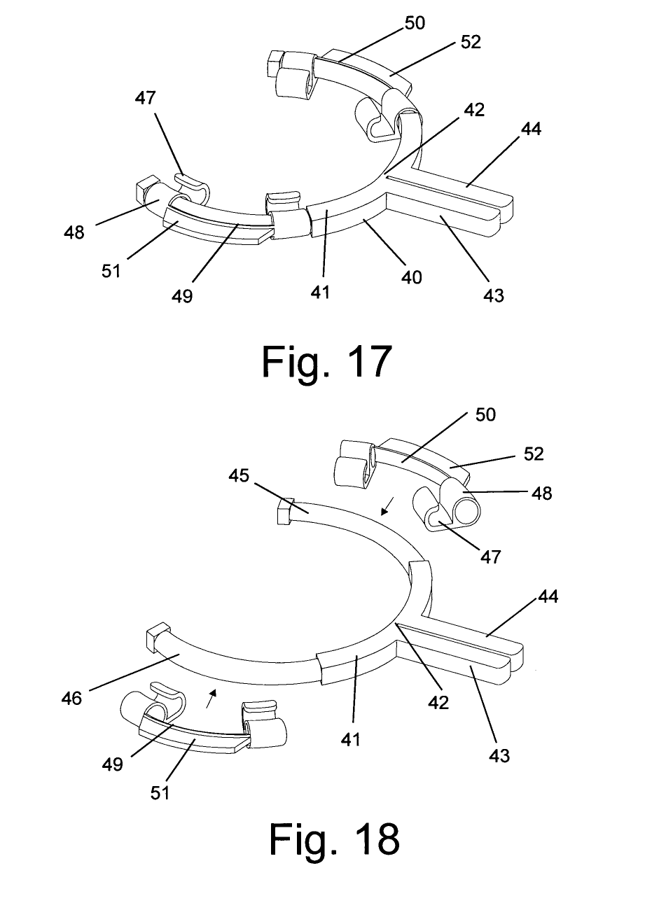

The rotation of the fasteners is possible not only around the connection, but also together with said connection, or around a part of said connection. A holder 40 represented in FIGS. 17-18, includes an arc-shaped band 41 with an elastic connector 42 in the middle of said band, and two radial handles 43 and 44 placed on both sides of the connector 42. Therewith, when the connector 42 is not strained, the area defined by the holder is reduced, and handles 43 and 44 are apart (not shown).

As shown in FIG. 18, circular-section parts 45 and 46 of the band 41 are used to place fasteners 47 thereon. Fasteners 47 are formed as hooks and provided with a ring 48 on one end; said ring is put on the parts 45, 46 of the band 41 in such way that the inner diameter of the ring matches the diameter of the band 41 at parts 45, 46. The fasteners are alternately connected by an arc-shaped connector 49, 50 with angle of flexure thereof matching the angle of flexure of band 41 at parts 45, 46. A lever 51, 52 formed as a plate is attached to each connector 49, 50 on the outer side thereof.

When putting on the condom (not shown), the user holds the holder 40 with digits of one hand by the handles 43 and 44, bringing said handles together as shown in FIG. 17, then the holder 40 is displaced towards the base of the penis. Afterwards, the levers 51, 52 are pressed in such manner that fasteners 47 rigidly connected to connectors 49, 50 are rotated in a direction opposite to that in which the hooks of said fasteners are bent. When the fasteners 47 are rotated about a certain angle, the edge of the condom can leave the hooks of the fasteners without hindrance. After the edge of the condom is released, the holder is removed in transverse direction.

Another modification of the fasteners is possible. E.g., the fasteners can be noose-shaped and adapted to hold the condom ring on the outer side.

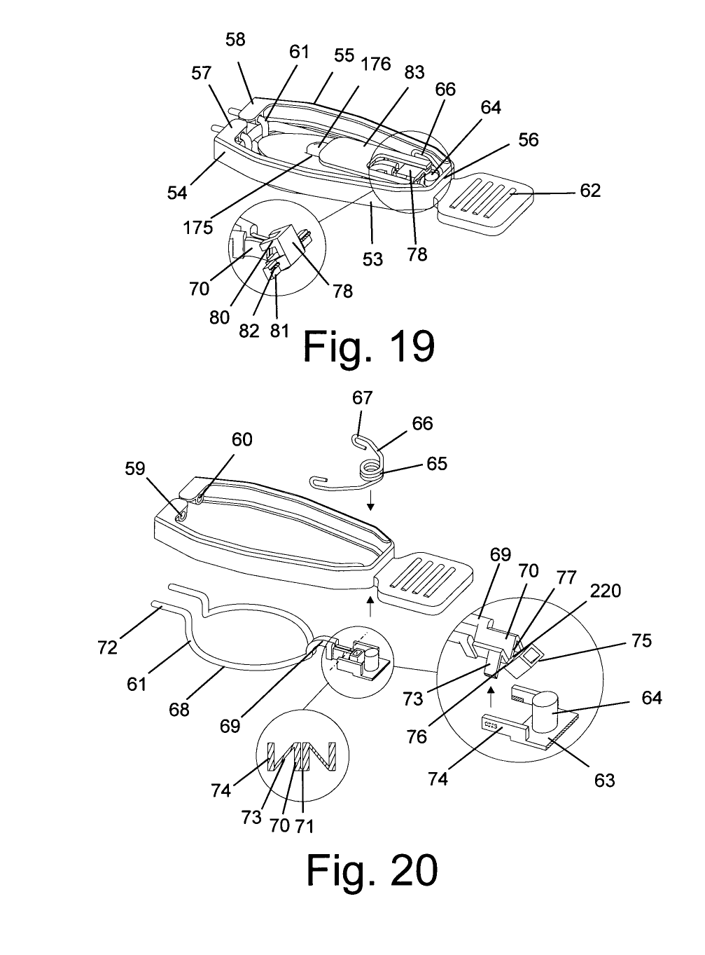

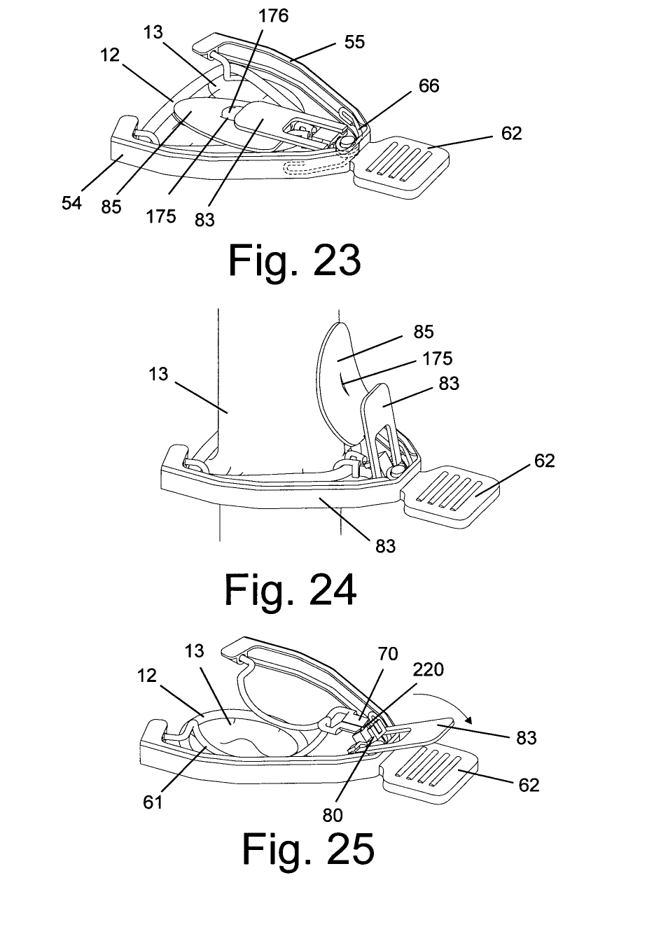

In FIG. 19-25, a holder 53 is shown provided with two profiles 54 and 55 slightly bent outwards and connected to each other by an elastic connector 56. Profiles 54 and 55 are U-shaped in section and are faced towards each other with their inner sides, while the free ends 57, 58 thereof are bent towards each other. Openings 59 and 60 are formed on the ends 59 and 60 (FIG. 20) used to place two fasteners 61 therein. Axes of the openings 59 and 60 are parallel with respect to one another, and are in plane parallel to the condom plane. A handle 62 is attached to the connector 56 on the outer side of the holder 53. A platform 63 formed as a plate in condom plane is attached to the connector 56 on the inner side thereof. A rod 64 with turns 65 of a spring 66 placed thereon is formed on the platform 63. Free ends 67 of the spring rest upon the inner sides of profiles 54 and 55 and tend to bring said profiles apart due to elastic forces.

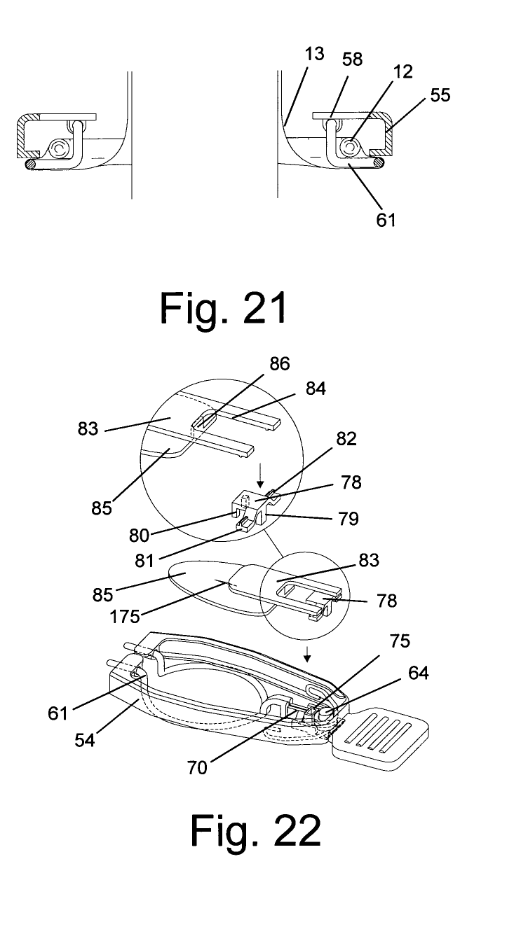

Each fastener 61 is formed as a wire with an arc-shaped part 68 and two ends 69 and 72 (FIG. 20). Plates 70 connected to each other with an elastic connector 71 and adapted to a hinge rotation (?) are formed on the ends 69 of the fasteners 61. Other ends 72 of the fasteners 61 are hinged in the openings 59, 60. The fasteners 61 embrace the rolled edge 12 of the condom 13 on the outer side thereof, as shown in FIG. 21.

Flexible bands 73 connect the plates 70 to the planks 74 formed on the sides of the platform 63 and arranged perpendicularly with respect to said platform. In FIG. 20, an enlarged sectional view of the connection between the plates 70, the bands 73 and the planks 74 is shown.

A sleeve 75 with an opening of rectangular section is attached to the plates 70 on the edge 77 thereof at the area where the connector 71 is placed with one end by a flexible connector 220, shown enlarged in FIG. 20. In a folded state of the holder 53, the sleeve 75 is placed between the edge 77 and the rod 64, and the axis of the sleeve 75 is parallel to the plane of the edge 77, as shown in FIG. 22.

A platform 78 is a plate with a pin 79 of rectangular section on one side thereof; said pin is placed into the sleeve 75 and held therein by friction forces between the sides of the pin 79 and the inner sides of the sleeve 75. The fixation of the pin 79 in the sleeve 75 can also be provided by hooks on the surface of the pin 79 or by bonding, e.g. with glue (not shown in figures). Locking lugs 80 embracing the plates 70 and retaining said plates in a folded state are placed on the same side of the platform 78 (FIG. 22). Lugs 81 are placed on the sides of the platform 78; said lugs are shifted with respect to the plane of the platform 78 towards the pin 79, a handle 83 formed as a flat plate is attached to said lugs with two flexible connectors 82. The handle 83 is provided with a cutout 84 with the platform 78 placed therein.

The platform 78 with the handle 83 placed thereon forms a lever used to rotate the fasteners 61. Therewith, the pivot of the lever is located at the point of contact between the sleeve 75 and the rod 64; said point of contact appears when the lever is affected as described below.

Furthermore, the holder 53 is provided with means of removing the air from the closed end of the condom formed as a plate 85 with a slot 175; said plate is attached to the handle 83 by a connector 86 and is placed in the condom plane in the area defined by bonds 54, 55. When the condom 13 is placed into the holder 53, the closed end 176 of the condom is placed into the slot 175; the air from said closed end is previously removed.

When putting on the condom, the user holds the holder 53 with digits of one hand by a handle 62 and displaces said holder towards the base of the penis as shown in FIG. 24. At the beginning of said displacement, the penis rests upon the plate 85 adjacent to the closed end of the condom 13 (not shown), thus preventing the air flow to said closed end. The further displacement of the holder leads to the plate 85 being bent off, and the closed end of the condom leaves the slot 175. The handle 83 starts to bend off together with the plate 85. When the condom is put on, the user affects the lever by turning the handle 83 towards the handle 62, as shown with an arrow in FIG. 25. The plates 70 therefore leave the locking lugs 80, and the sleeve 75 is rotated towards the rod 64 and rests thereupon. The point of contact between the sleeve 75 and the rod 64 forms the pivot of the lever. The pivot of the lever can be formed in another point of the holder, e.g. in the point of connection between bands 54, 55 (not shown in figures).

The further turning of the handle 83 leads to the end 76 of the sleeve 75 starting to rise up; said end raises up the connected edges of the plates 70 (FIG. 25). Due to the fact that the open edges of the plates 70 are retained with respect to the planks 74 by the bands 73, said ends stay fixed. As a result, the plates 70 are rotated away from each other and are placed basically in one plane. Therewith, the fasteners 61 rigidly connected to the plates 70 are also rotated, and the rolled edge 12 of the condom 13 leaves said fasteners without hindrance. After the edge of the condom is released, the holder is removed in transverse direction.

In the embodiment described above, the fastener rotation mechanism can be provided in another way.

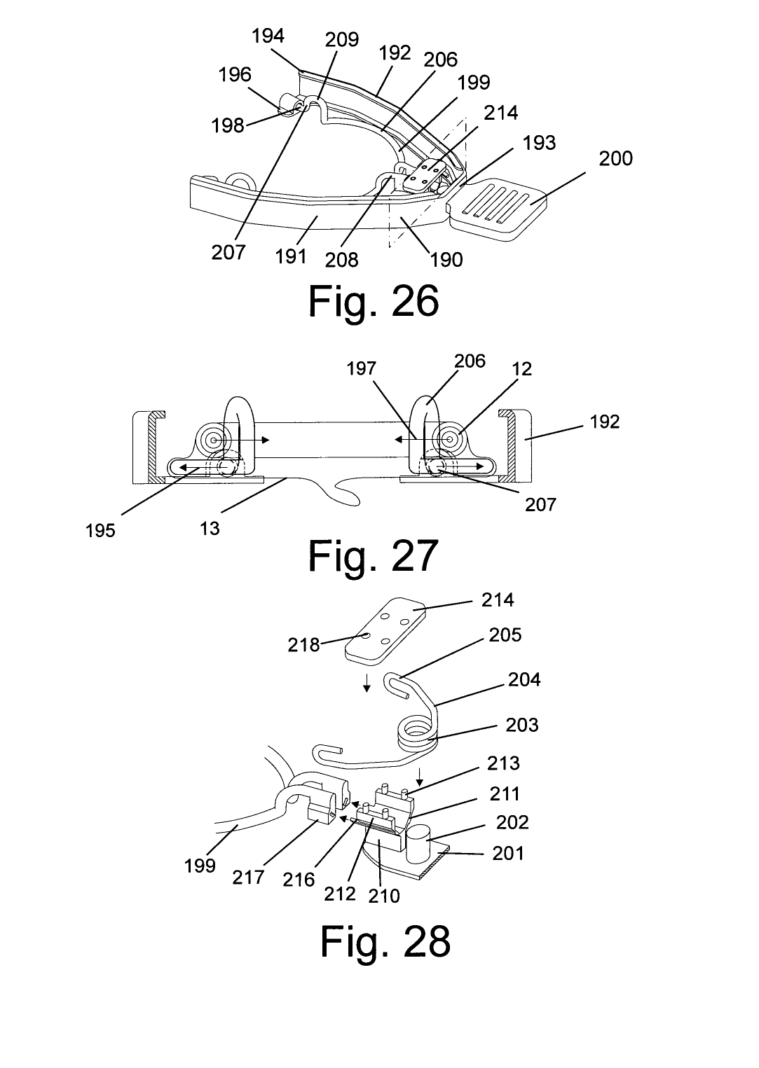

As shown in FIGS. 26-31, a holder 190 is similar to the holder 53 and is provided with two profiles 191 and 192 slightly bent outwards and connected to each other by a flexible connector 193. Profiles 191 and 192 are U-shaped in section and are faced towards each other with their inner sides, while the free ends 194 thereof are provided with lugs 196 having openings 198 used to place fasteners 199 therein. A handle 200 is attached to the connector 193 on the outer side of the holder 190. A platform 201 is attached to the connector 193 on the inner side thereof (FIG. 28); said platform is formed as a plate in condom plane. A rod 202 with turns 203 of a spring 204 placed thereon is formed on the platform 201. Free ends 205 of the spring rest upon the inner sides of profiles 191 and 192 and tend to bring said profiles apart due to elastic forces.

Each fastener 199 is formed as a wire with an arc-shaped part 206 located in condom plane when the fasteners are in home position (non-rotated), and two ends 207 and 208. Furthermore, arc-shaped parts 209 are placed on the ends 207 of the fasteners; the arc radius of said parts is smaller than that of arc-shaped parts 206. Arc-shaped parts 209 used to place the condom ring 12 therein are perpendicular to arc-shaped parts 206 (see FIG. 26). Therewith, the ends 207 are in one plane with arc-shaped parts 209. In the mentioned design of the fasteners 199, the axes of rotation thereof are located basically on the line connecting ends 207 and 208 of the fasteners 199. Said lines are located below the condom plane, in contrast to the embodiment where fasteners similar to the fasteners 61 are used (see FIG. 20. With said arrangement of the axes, when the bands 191, 192 are brought apart (the direction is shown by arrows in FIG. 27), the fasteners 199 are locked in the home position (non-rotated) by the ring 12 of the condom 13 (FIG. 27), due to elastic forces forming when the edge 12 of the condom is stretched; said elastic forces are applied in a direction shown by arrows 197. Thus, there is no need to lock the fasteners 199 when the profiles 191, 192 are rotated.

A pin 210 formed as a rectangular plate is placed on a platform 201 perpendicular to the platform 201. Two plates 211 are attached to the free end of the pin 210 at an angle with respect to each other, as shown in FIGS. 28, 30. Plates 212 placed in one plane with the pin 210 are attached to the plates 211. The plates 212 are provided with rods 213 used to place a rest 214 formed as a plate. The rest 214 is provided with openings 218 used to place rods 213 therein. The edges of plates 211 are flexible, in order to provide the rotation thereof with respect to the pin 210 and the plates 212. Furthermore, lugs 216 are formed on the outer side of each plate 211.

Plates 217 are formed on the ends of the fasteners 199 attached to the lugs 216 (see FIG. 28).

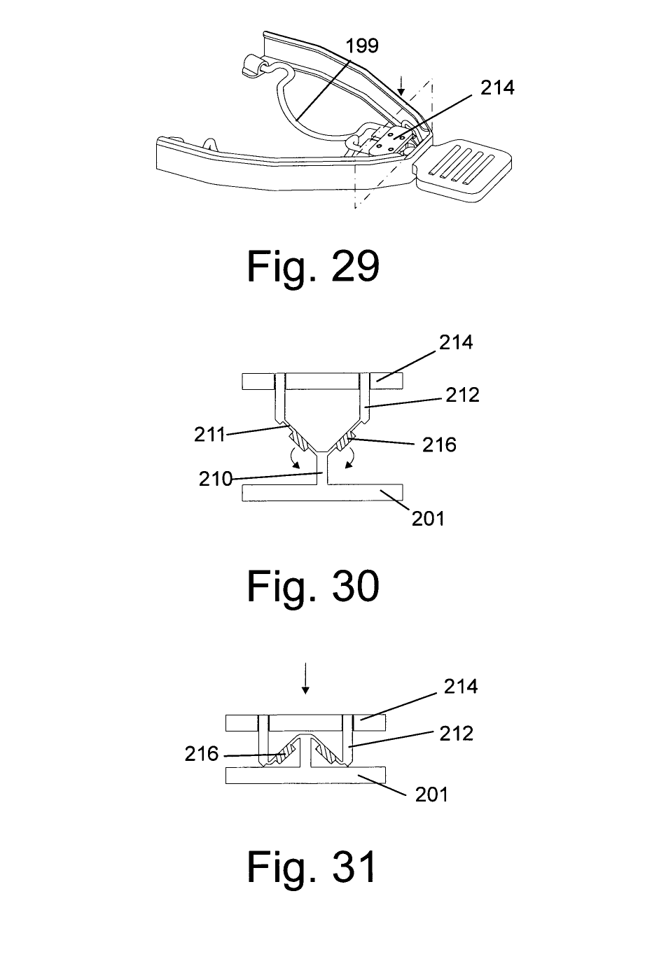

When releasing the condom from the holder 190, the user rotates the fasteners 199. In order to perform this, the user presses the rest 214 in a direction shown by an arrow in FIG. 29. Therewith, the plates 211 are rotated in a direction shown by arrows in FIG. 30. Simultaneously with the rotation of the plates 211, the plates 217 and, subsequently, the fasteners 199 are rotated.

As described above, the release of a condom from a holder can be performed by providing fasteners adapted to rotate. However, the fasteners rigidly attached to the holder can also be used; said fasteners are provided with pushing members that release the edge of the condom from the grip when displaced.

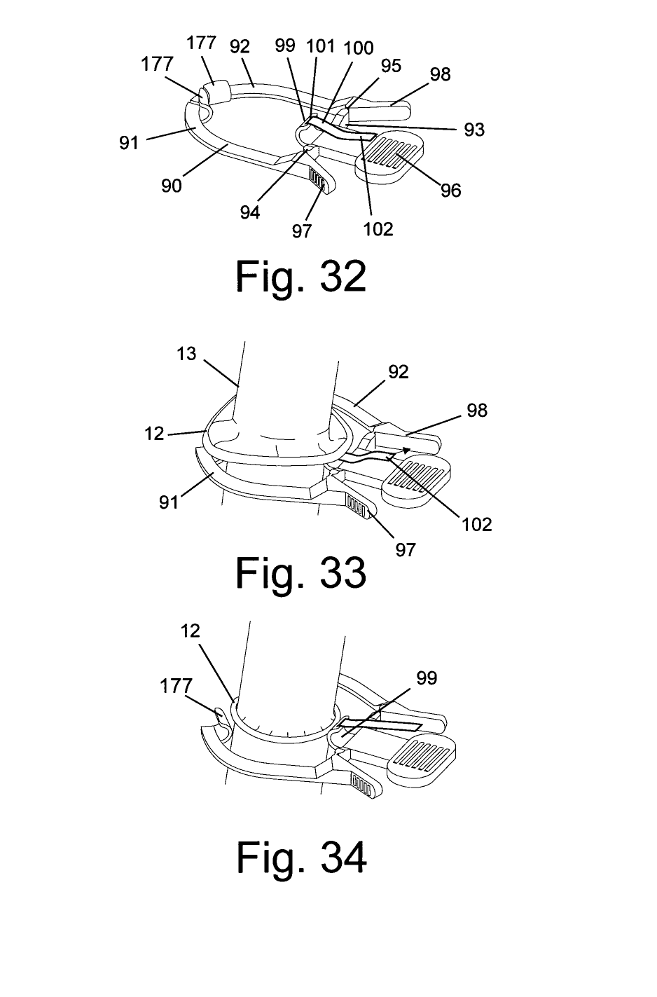

E.g., in the embodiment represented in FIGS. 32-34, a holder 90 includes two arc-shaped bands 91 and 92 attached to a rod 93 on the ends thereof by flexible connectors 94 and 95 and adapted to a hinged rotation. The holder 90 includes two hooks 177 attached to the free ends of the arc-shaped bands 91 and 92, and a hook 99 attached to the rod 93 on the inner side thereof. A handle 96 is attached to the rod 93 on the outer side thereof. Handles 97 and 98 are attached to the bands 91 and 92 at the spot where said bands are attached to the rod 93. The band 91 with the handle 97, and the band 92 with the handle 98 form the levers with the pivots thereof placed on the corresponding ends of the rod 93. The holder 90 is provided with a flexible ribbon 100 with one end thereof attached to the bent end of the hook 99, e.g. it can be glued (FIG. 32). When the condom 13 is placed into the holder 90, the ribbon 100 is placed inside the hook 99 (FIG. 33) under the rolled edge 12 of the condom. The other end 102 of the ribbon 100 remains outside (FIG. 33).

When putting on the condom, the user holds the holder 90 by handles 97 and 98 and displaces said handles towards each other; the area defined by the holder is therefore expanded, and the rolled edge 12 of the condom 13 is stretched. Then the user starts to displace the holder 90 towards the base of the penis (FIG. 33). After the condom is put on, the user pulls the free end 102 of the ribbon 100 in a direction shown with an arrow in FIG. 33. The ribbon 100 therefore leaves the hook 99 and pushes the edge 12 of the condom out of said hook. After the edge of the condom is released from the hook 99, the release of the edge 12 of the condom from the hooks 177 is substantially alleviated. In FIG. 34, an arrangement is shown when the condom 13 is fully released from the holder 90. After the edge of the condom is released, the holder is removed in transverse direction.

A modification is possible, where each hook is provided with a similar ribbon. Furthermore, a holder can be provided with a device that allows to affect all said ribbons simultaneously.

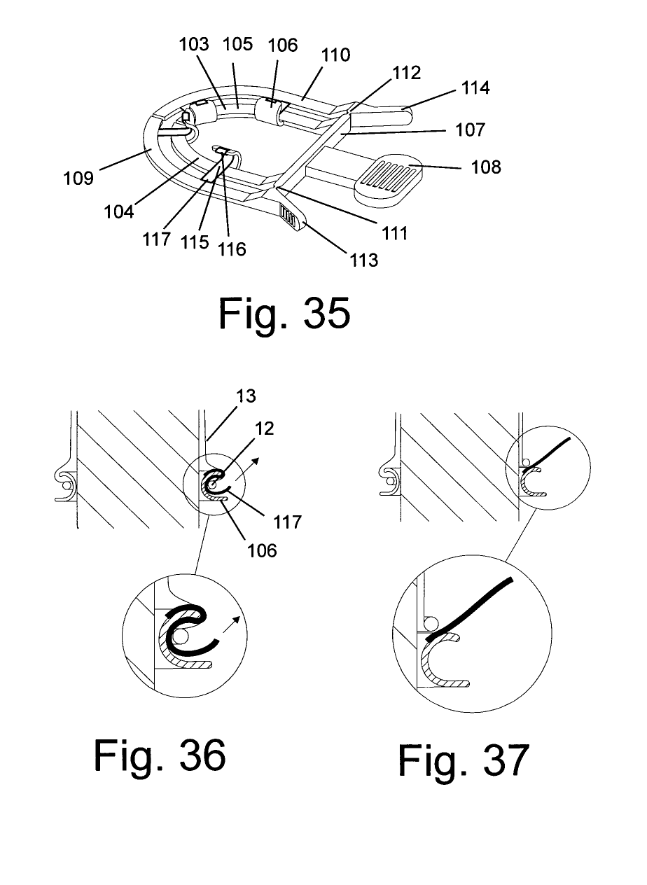

As shown in FIG. 35, a holder 103 includes two arc-shaped bands 104 and 105 provided with hooks 106 protruding into the holder; said bands are attached to a rod 107. A handle 108 is attached to the rod 107 on the outer side thereof. Arc-shaped bands 109 and 110 are attached to the ends of the rod 107 by flexible connectors 111 and 112; said bands are adapted for a hinge rotation (?). The bands 109 and 110 match the shape of the bands 104 and 105 and are in the same plane therewith. In this embodiment, it is assumed that the area defined by the bands 104 and 105 is sufficient for putting on the condom.

Handles 113 and 114 are attached to the bands 109 and 110 at the spot where said bands are attached to the rod 107. Therewith, the band 109 with the handle 113, and the band 110 with the handle 114 form the levers with the pivots thereof placed on the corresponding ends of the rod 107. The holder 103 is provided with four ribbons 115 (the number thereof defined by the number of hooks 106). One end 116 of each band 115 is attached to the hook 106, and the ribbon 115 is placed inside the hook 106 similarly to the embodiment described with reference to FIGS. 32-34. The difference is that the other end 117 of each ribbon 115 is attached to the corresponding band 109, 110, e.g. glued.

When putting on the condom, the user holds the holder 103 by a handle 108 and displaces said holder towards the base of the penis. After the condom is put on, the user affects the handles 113, 114 with digits of the same hand holding the holder and displaces said handles towards each other. Thus, the bands 109 and 110 are brought apart from each other, pulling the ribbons 115 that leave the hooks 106 and push the edge of the condom releasing it from all hooks (FIG. 37). After the edge of the condom is released, the holder is removed in transverse direction if the bands 104, 105 are flexible, or in a longitudinal direction if the bands 104, 105 are rigid.

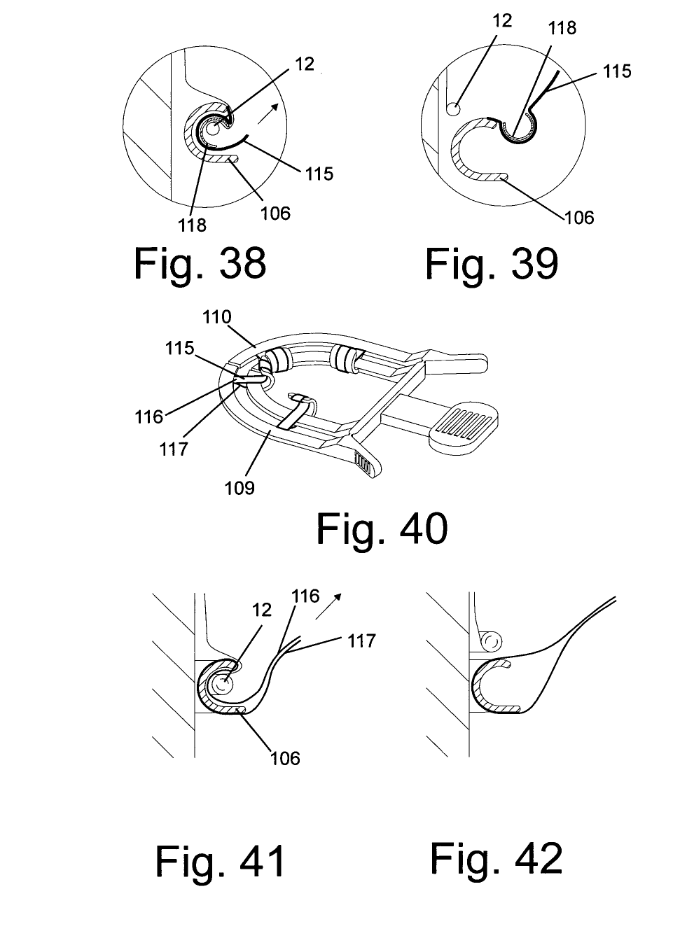

As shown in FIGS. 38-39, a ribbon 115 can be additionally provided with a semi-ring 118 that provides additional rigidity to the ribbon 115 and facilitates the removal of the rolled edge 12 of a condom from a hook 106. The semi-ring 118 is placed in the hook 106 and matches the shape thereof. The rolled edge 12 of the condom 13 is placed in the semi-ring 118, and the ribbon 115 passes between the semi-ring 118 and the hook 106. The removal of the edge 12 of the condom is similar to the one described with reference to FIGS. 36-37.

In yet another embodiment shown in FIGS. 40-42, a ribbon 115 is not attached to a hook 106, but embraces said hook (FIGS. 40, 41). Therewith, as in the previous embodiments, a part of the ribbon is placed inside the hook 106 between said hook and the rolled edge 12 of the condom 13. Both ends 116, 117 of each ribbon 115 are attached to the bands 109, 110 (FIG. 40). The process of putting on the condom shown in FIGS. 41, 42, is similar to that shown in FIGS. 36, 37.

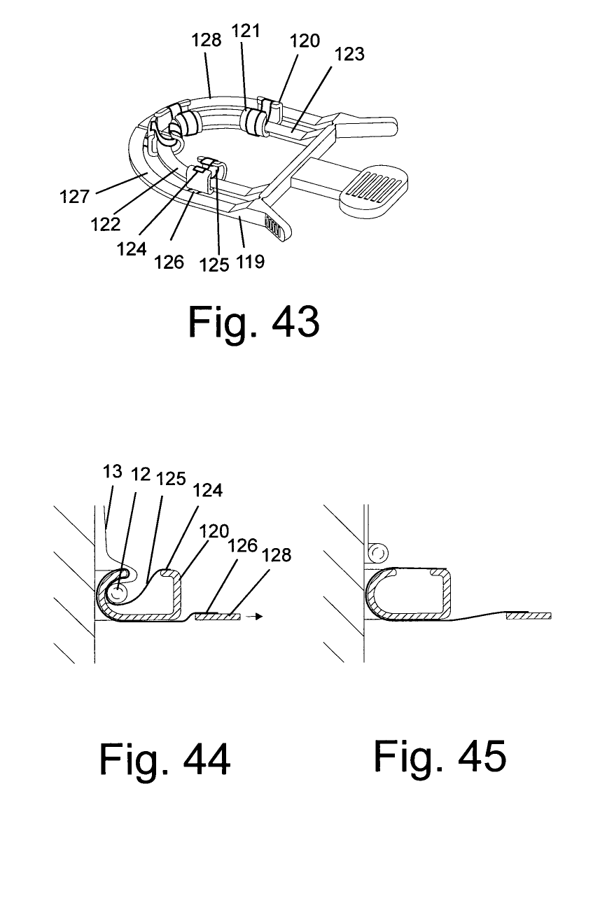

A holder 119 shown in FIGS. 43-45 is similar to the holder 103 shown in FIG. 35. The difference is that each fastener is formed by two hooks 120 and 121 attached to inner bands 122, 123 on both sides thereof and faced towards each other with inner sides thereof as shown in FIG. 43. One end 124 of the ribbon 125 is attached to the hook 120. The ribbon 125 is placed in the area defined by the hooks 120 and 121 and embraces the hook 121 on the outer side thereof. End 126 of the ribbon 125 is attached to the corresponding outer band 127, 128. The process of putting on the condom with the holder 119, shown in FIGS. 44-45, is similar to that with the holder 103, shown in FIGS. 36-37.

In a modification where the fastener is formed as a noose-shaped wire grasping the rolled edge of the condom on the outer side thereof, similarly to the fasteners 61 shown in FIG. 20, the ribbons can also be used.

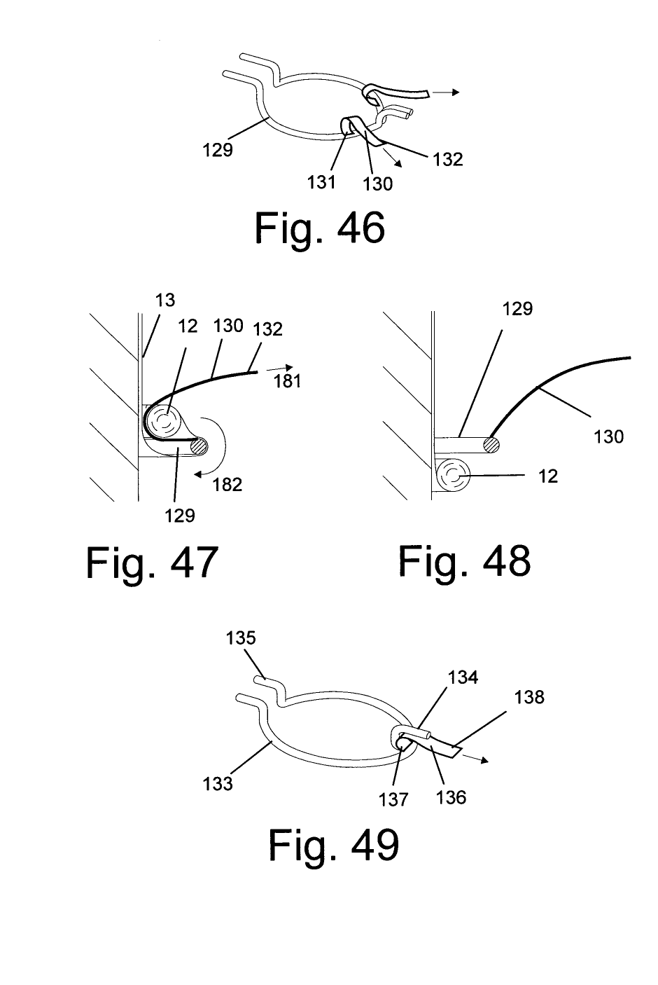

In an embodiment shown in FIGS. 46-48, a holder (not shown) is provided with two fasteners 129; one ribbon 130 is attached to each of said fasteners. Therewith, an end 131 of the ribbon 130 is attached to the fastener 129, and an end 132 of the ribbon 130 is free. When a condom 13 is placed into the holder (FIG. 47), each ribbon embraces the edge 12 of the condom 13 on the outer side thereof. When the end 132 of the ribbon 130 is affected in a direction shown with an arrow 181 in FIG. 47, the ribbon 130 shifts the rolled edge 12 of the condom 13, which is displaced in a direction shown with an arrow 182. In FIG. 48, an arrangement is shown when the condom 13 is fully released from the holder.

A holder can be provided with one fastener 133 formed as an open ring shown in FIG. 49. An arched L-shaped rod 134 is attached to the fastener 133 and is used to fixate the fastener 133 with respect to the holder (not shown in figures); said rod is placed opposite to the ends 135 of said fastener. A ribbon 136 is attached to the fastener 133 at the base of the rod 134 with one end, and is placed on the inner side of said rod. An end 138 of the ribbon is free. The release of the condom from the holder (not shown) is performed by affecting the free end 138 of the ribbon 136 in a direction shown with an arrow.

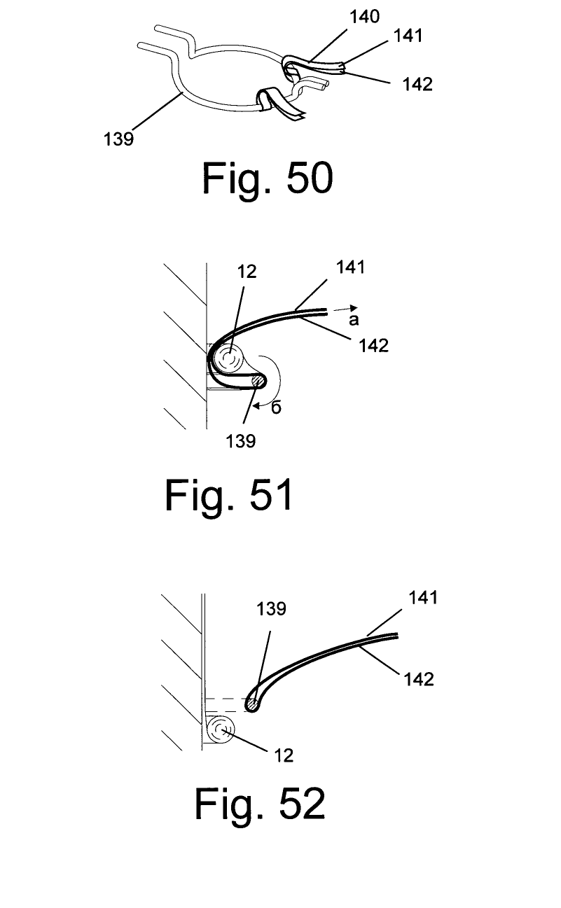

In the embodiment represented in FIGS. 50-52, each fastener 139 is provided with a ribbon 140 embracing said fastener, and ends 141, 142 of said ribbon are adapted to be affected simultaneously. The process of releasing the edge 12 of the condom from the holder (not shown) shown in FIGS. 50, -52, is similar to that shown in FIGS. 47, 48.

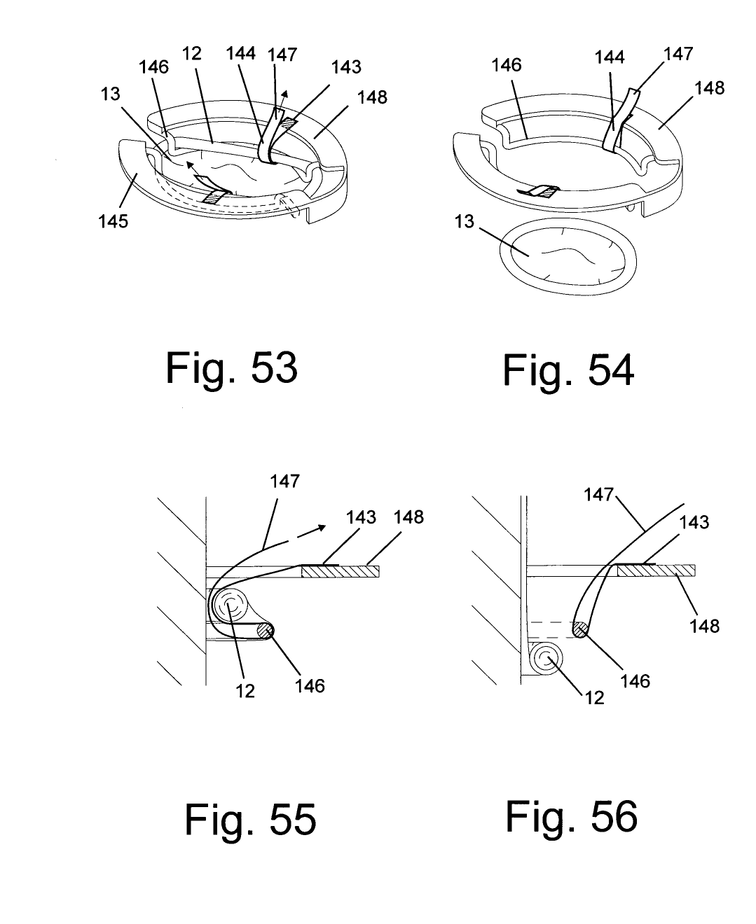

In yet another embodiment shown in FIGS. 53-56, one end 143 of each ribbon 144 is attached directly to bands 148 of a holder 145, e.g. it can be glued. The ribbon 144 embraces a fastener 146, and an end 147 is free. When the condom 13 is placed into the holder 145, the ribbon 144 embraces the condom on the outer side thereof, as shown in FIG. 55. The release of the edge 12 of the condom from the holder 145 is performed by affecting the end 147 of the ribbon 144 in a direction shown with an arrow in FIGS. 53, 55. In FIGS. 56 54, an arrangement is shown when the condom 13 is fully released from the holder.

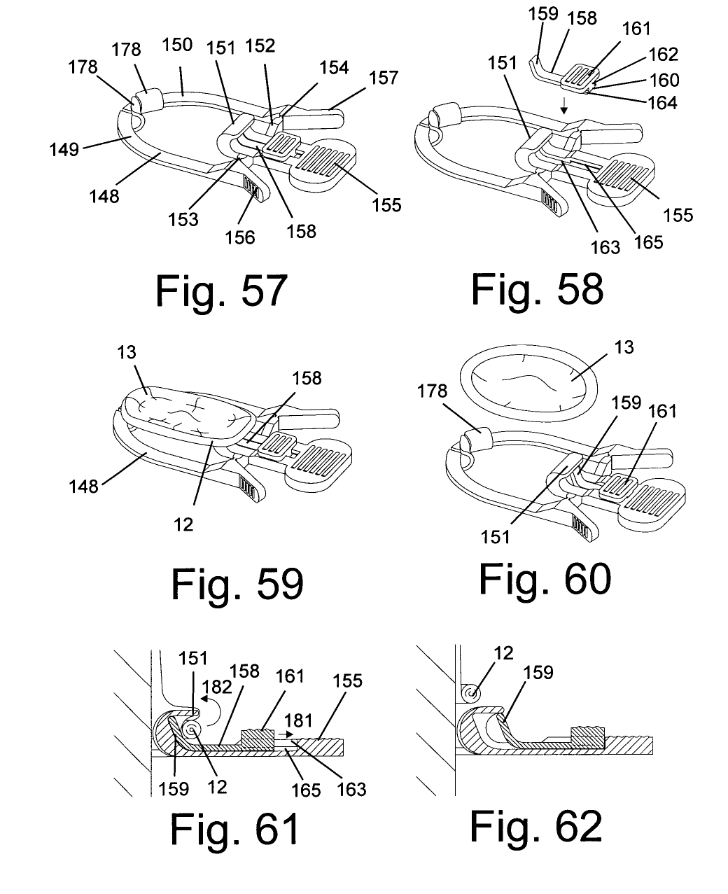

In the embodiment represented in FIGS. 57-62, a holder 148 is similar to the holder 90, represented in FIG. 32. The holder 148 includes two arc-shaped bands 149, 150. The bands 149, 150 are attached to a rod 152 by flexible connectors 153 and 154 on two sides of said rod. A handle 155 is attached to the rod 152 on the outer side thereof. Handles 156 and 157 are attached to the bands 149 and 150 at the spot where said bands are attached to the rod 152. The band 149 with the handle 156, and the band 150 with the handle 157 form the levers with the pivots thereof placed on the connectors 153 and 154 respectively.

The holder 148 is provided with three fasteners formed as hooks, two of said fasteners are attached to the bands 149, 150 on the free ends thereof, and one fastener 151 is attached to the holder on the inner side of the rod 152. The difference is that a pushing member 158 formed as a plate is used instead of a ribbon; said pushing member is placed on the holder 148 and is adapted to displace. The pushing member 158 includes a bent end 159 placed inside the hook 151 (FIG. 58). A rest 161 is formed on the other end 160 of the pushing member 158; said rest is a button or a key with shape and size convenient to be affected by a digit; a pin 162 is placed under said button or key. The pin 162 is adapted to displace in a closed slot 163 partly passing through the handle 155 and the hook 151. Furthermore, the pushing member 158 is provided with lugs 164 placed on the end 160; said lugs are adapted to displace in slots 165 formed on the opposite walls of the slot 163. The slots 165 prevent the pushing member 158 from leaving the slot 163.

In FIGS. 59, 61, a holder with a condom 13 is shown. As it can be seen from the drawings, the bent end 159 of the pushing member 158 is placed under the rolled edge 12 of the condom 13.

The process of putting on the condom with the holder 148, shown in FIGS. 61-62, is similar to that with the holder 90 (FIG. 32). The difference is that after the condom is put on, the user displaces the pushing member 158 in a direction shown with an arrow 181 (FIG. 61), affecting the rest 161. The displacement of the end 159 of the pushing member 158 leads to a displacement of the edge 12 from the hook 151 in a direction shown with an arrow 182. At the moment when the pushing member 158 is fully extruded, the edge 12 of the condom is fully released from the hook 151 (FIG. 62). Therewith, the release of the edge 12 of the condom from the fasteners 178 is substantially alleviated.

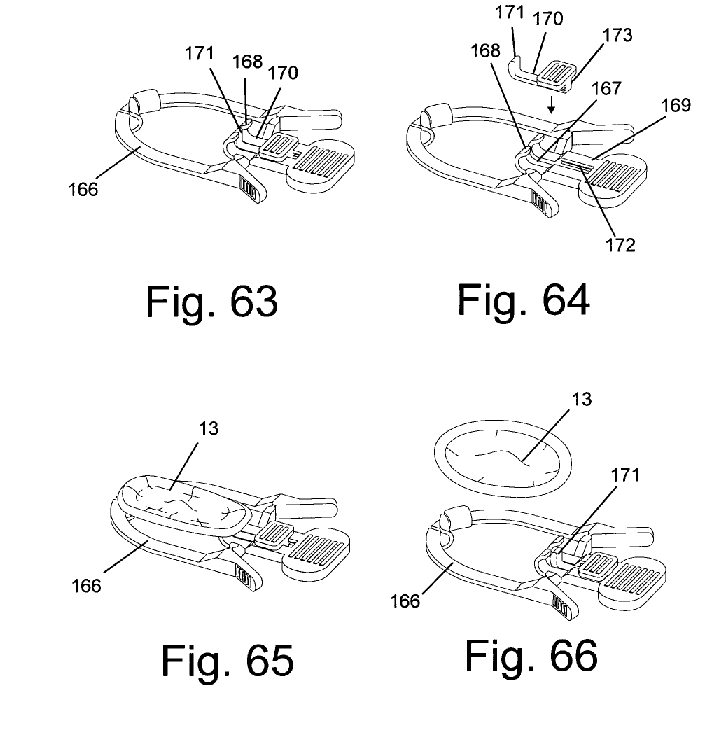

In an embodiment shown in FIGS. 63-66, a holder 166 is similar to the holder 148. The difference is that the holder 166 is provided with a through slot 167 passing through the whole hook 168 and a part of the handle 169. A pushing member 170 is provided with a bent end 171 with the outer surface thereof located at the same level with the outer surface of the hook 168 when the pushing member 170 is installed in the slot 167. The opposite sides of the slot 167 are provided with slots 172, and the pushing member 170 is provided with lugs 173 placed into the slots 172 and adapted to displace. The slots 173 prevent the pushing member 170 from leaving the slot 167 and restrict the forward displacement thereof.

The process of putting on the condom with the holder 166 (FIG. 63), is similar to that with the holder 148 (FIGS. 57-62).

Within the scope of the appended claims, the invention can be implemented in many embodiments other than those described herein.

I claim:

1. A condom holder with a means for releasing the condom from the holder, at least partially defining a space in which a flatly arranged condom can be placed, the holder including at least one fastener comprising a hook adapted for receiving the edge of the rolled condom therein, and a connection between said fasteners, wherein the at least one fastener is adapted to be rotated, characterized in that said rotation is allowed in a direction opposite to that in which its hook is bent, wherein the edge of the condom can go out of the fastener when said rotation of the fastener is effected.

2. A holder according to claim 1, characterized in that the holder includes a stopper preventing rotation of said fastener in a direction in which its hook is bent.

3. A holder according to claim 1, characterized in that at least one fastener is adapted to be rotated with respect to the connection.

4. A holder according to claim 1, characterized in that at least one fastener is adapted to be rotated along with the connection.

5. A holder according to claim 1, characterized in that said stopper prevents rotation of the fastener above the condom plane.

6. A holder according to claim 1, characterized in that said rotation of the fastener is provided by means of hinged connection.

7. A holder according to claim 1, characterized in that said rotation is provided by means of a flexible connector.

8. A holder according to claim 1, characterized in that at least two fasteners are adapted to rotate simultaneously.

9. A holder according to claim 1, characterized in that the connection includes at least one arc-shaped band.

10. A holder according to claim 9, characterized in that it is provided with a handle on the outer side of said arc-shaped band.

11. A holder according to claim 1, characterized in that it is adapted to change the shape of said connection between a first configuration in which said space is reduced, and a second configuration in which said space is expanded.

12. A holder according to claim 11, characterized in that said connection is elastic.

13. A holder according to claim 11, characterized in that it is provided with a holder locking device for locking the holder in the second configuration.

14. A holder according to claim 13, characterized in that it is provided with an elastic member tending to return the holder into the first configuration.

15. A holder according to claim 1, characterized in that it includes at least three fasteners arranged in such manner that a radial arc of at least 180° can be drawn through said fasteners.

16. A holder according to claim 1, characterized in that the fasteners are noose-shaped.

17. A holder according to claim 16, characterized in that the fasteners are adapted to hook the rolled edge of the condom on the outer side of said condom.

18. A holder according to claim 17, characterized in that it includes two fasteners adapted to rotate with respect to the connection simultaneously.

19. A holder according to claim 1, characterized in that the fasteners are adapted to hook the rolled condom ring on the inner side of said condom.

20. A condom holder provided with a means for releasing the condom from the holder, at least partially defining a space in which a flatly arranged condom can be placed, the holder including at least one fastener with a hook adapted for receiving the edge of the rolled condom therein, and the connection between said fasteners, wherein the at least one fastener is adapted to be rotated, characterized in that it is provided with at least one rotating means adapted to be affected by the digits of a hand, the rotating means being rotatably connected to the at least one fastener, wherein its rotation is allowed in a direction opposite to that in which its hook is bent.

21. A holder according to claim 20, characterized in that at least one fastener is adapted to be rotated with respect to the connection.

22. A holder according to claim 20, characterized in that at least one fastener is adapted to be rotated along with the connection.

23. A holder according to claim 20, characterized in that the holder includes a stopper preventing rotation of said fastener in a direction in which its hook is bent.

24. A holder according to claim 23, characterized in that said stopper prevents rotation of the fastener above the condom plane.

25. A holder according to claim 20, characterized in that said rotation of the fastener is provided by means of hinged connection.

26. A holder according to claim 20, characterized in that said rotation is provided by means of a flexible connector.

27. A holder according to claim 20, characterized in that at least two fasteners are adapted to rotate simultaneously.

28. A holder according to claim 20, characterized in that the connection includes at least one arc-shaped band.

29. A holder according to claim 28, characterized in that it is provided with a handle placed on the outer side of said arc-shaped band.

30. A holder according to claim 20, characterized in that the rotating means include a lever.

31. A holder according to claim 20, characterized in that it is adapted to change the shape of said connection between a first configuration in which said space is reduced, and a second configuration in which said space is expanded.

32. A holder according to claim 31, characterized in that it is provided with a holder locking device for locking the holder in the second configuration.

33. A holder according to claim 31, characterized in that said connection is provided with an elastic member tending to return the holder into the first configuration.

34. A holder according to claim 20, characterized in that it includes at least three fasteners arranged in such manner that a radial arc of at least 180° can be drawn through said fasteners.

35. A holder according to claim 20, characterized in that the fasteners are connected by means of a connector, and the holder includes a displacement means for dispacing said connector in a direction perpendicular to the condom plane; wherein the rotation of the fasteners is provided by said displacement of said connector.

36. A holder according to claim 35, characterized in that the displacement means include a lever having one its end attached to the connector, wherein the other end of the lever is adapted to be affected by the digits of a user's hand; the pivot of the lever being located on the connection between said fasteners.

37. A holder according to claim 20, characterized in that it includes a locking means for locking the fasteners in their home position connected to the means of displacing the connector.

38. A condom holder provided by a means for releasing the condom from the holder, at least partially defining a space in which a flatly arranged condom can be placed, the holder including at least one fastener comprising a hook adapted for receiving the edge of the rolled condom therein, and a connection between said fasteners, characterized in that it includes at least one condom edge pushing member provided with a means allowing the user to affecting said pushing member and contact said pushing member with the edge of the condom and displace said edge with respect to at least one hook.

39. A holder according to claim 38, characterized in that the fasteners are adapted to hook the rolled condom ring on the inner side of said condom.

40. A holder according to claim 38, characterized in that the fasteners are noose-shaped.

41. A holder according to claim 40, characterized in that the fasteners are adapted to hook the rolled condom ring on the outer side of said condom.

42. A holder according to claim 38, characterized in that the pushing member includes a ribbon.

43. A holder according to claim 42, characterized in that the ribbon is attached to the hook.

44. A holder according to claim 42, characterized in that the ribbon is placed on the inner side of the hook.

45. A holder according to claim 42, characterized in that the ribbon embraces the hook.

46. A holder according to claim 45, characterized in that the end of the ribbon is attached to the connection.

47. A holder according to claim 38, characterized in that the pushing member includes a semi-ring placed on the inner side of the hook.

48. A holder according to claim 38, characterized in that it includes at least one more pushing member, and a means for simultaneously affecting said pushing members.

49. A holder according to claim 38, characterized in that it includes a guideway, and the pushing member includes a plate with L-shaped profile adapted to displace along said guideway.
